(19) United States
(12) Patent Application Publication
(10) Pub. No.: US 2026/0037244 A1
(43) Pub. Date: Feb. 5, 2026

(54) CHARGER-BASED VEHICLE SOFTWARE UPDATE VALIDATION

(71) Applicant: Ford Global Technologies, LLC, Dearborn, MI (US)

(72) Inventors: Matthew Roseman, Farmington Hills, MI (US); Neal Callinan, Saint Paul, MN (US); Chandrakant KULKARNI, Canton, MI (US); Ryan O’GORMAN, Beverly Hills, MI (US); Stuart C. Salter, White Lake, MI (US); Brendan F. Diamond, Naples, FL (US)

(21) Appl. No.: 18/788,364

(22) Filed: Jul. 30, 2024

(51) Int. Cl. G06F 8/65; G06F 11/36

(52) U.S. Cl. CPC G06F 8/65; G06F 11/3688

(57) ABSTRACT

Iterative software updating using consumer vehicles includes sending update requests to perform software updates to vehicles and charging stations in a cycle of testing, wherein the vehicles are included on an update list; receiving testing reports from the vehicles and charging stations; responsive to the testing reports indicating success above a minimum success threshold, continuing to roll out the software update in an additional cycle of testing; and otherwise, sending reversion update requests to roll back the software update to the vehicles and the charging stations.

### TECHNICAL FIELD

Aspects of the disclosure generally relate to charger-based vehicle software update validation.

### BACKGROUND

Vehicle over-the-air (OTA) software downloads may use cellular data or local Wi-Fi, typically at home. Charging stations at home have repeated opportunities to connect to home networks. Charging stations typically connect to vehicles through a wired charging coupler, similar to local area network (LAN) lines for computers. Charging stations can also connect wirelessly via Bluetooth Low Energy (BLE), Wi-Fi, etc.

### SUMMARY

In one or more illustrative examples, a method for iterative software updating using consumer vehicles includes sending update requests to perform software updates to vehicles and charging stations in a cycle of testing, wherein the vehicles are included on an update list; receiving testing reports from the vehicles and charging stations; responsive to the testing reports indicating success above a minimum success threshold, continuing to roll out the software update in an additional cycle of testing; and otherwise, sending reversion update requests to roll back the software update to the vehicles and the charging stations.

In one or more illustrative examples, a system for iterative software updating using consumer vehicles, includes a storage maintaining vehicle information, the vehicle information including records indicative of when vehicles are historically connected to which of the charging stations and parameters with respect to configuration and/or features of the vehicles; and a charger monitoring server configured to identify an update list of vehicles to receive a software update, send update requests to apply the software update to the vehicles on the update list, receive testing reports from the vehicles and the charging stations, responsive to the testing reports indicating success above a minimum success threshold, continue to roll out the software update in an additional cycle of testing, and otherwise, send reversion update requests to roll back the software update to the vehicles and the charging stations.

In one or more illustrative examples, a non-transitory computer-readable medium comprising instructions for iterative software updating using consumer vehicles that, when executed by a charger monitoring server, cause the charger monitoring server to perform operations including to maintain vehicle information, the vehicle information including records indicative of when vehicles are historically connected to which of charging stations and parameters with respect to configuration and/or features of the vehicles; identify an update list of vehicles to receive a software update; send update requests to apply the software update to the vehicles on the update list; receive testing reports from the vehicles and charging stations; responsive to the testing reports indicating success above a minimum success threshold, continue to roll out the software update in an additional cycle of testing, and otherwise, send reversion update requests to roll back the software update to the vehicles and the charging stations.

### BRIEF DESCRIPTION OF THE DRAWINGS

FIG. 1 illustrates an example system implementing an iterative testing approach for updating software using consumer vehicles;

FIG. 2 illustrates an example process for performing a simultaneous installation of a software update to the vehicle and to the charging station;

FIG. 3 illustrates an example process for the charger monitoring server implementing a testing approach to OTA software updates; and

FIG. 4 illustrates an example computing device for implementing an iterative testing approach to software updates using consumer vehicles.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

New vehicle charging software is validated through testing on a test fleet of vehicles and chargers. This approach is limited by the available chargers and test vehicles, usually fewer than a dozen, and does not cover all in-market variations that can result in defects. As software and charging capabilities advance, such as bidirectional power from the vehicle battery to the house, verifying proper function and adequate download time becomes more dependent. Often, both the vehicle and the charging station may require a simultaneous software update for proper operation.

An improved approach to vehicle software validation and rollout may implement a testing approach where software updates are rolled out to customer vehicles in an iterative approach. In the approach, a server identified vehicles to obtain statistically relevant samples from different market populations. These groups consider variations in climate, thermal temperatures from previous records, brands and series of vehicles, power levels, and installation characteristics.

The server sends the software updates to be installed to the vehicles and the charging stations in a cycle of the testing. Then, the software updates may be installed, tested, and testing reports including results of the installation and tests may be reported back to the server. Responsive to the testing reports indicating success above a minimum success threshold, the server continues to roll out the software update in an additional cycle of testing. If not, the server sends reversion update requests to roll back the software update to the vehicles and the charging stations. Further aspects of the disclosure are discussed in detail herein.

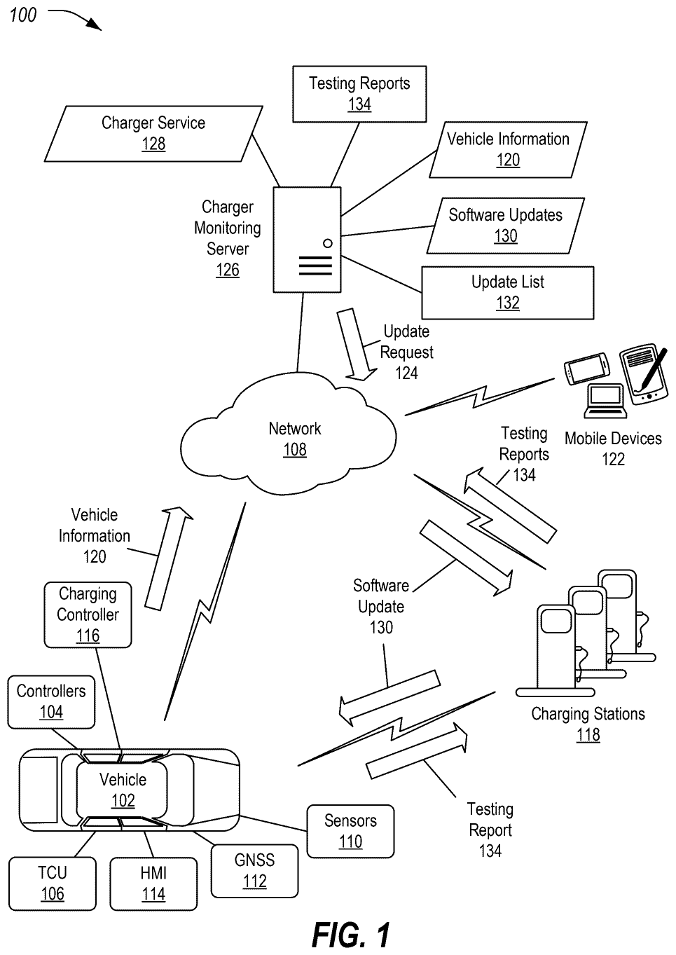

FIG. 1 illustrates an example system 100 implementing an iterative testing approach for updating software using consumer vehicles 102. The system 100 includes a vehicle 102 having various controllers 104. These controllers 104 include a telematics control unit (TCU) 106 to allow the vehicle 102 to communicate with remote devices over a communications network 108. These controllers 104 may also include a global navigation satellite system (GNSS) controller 112, a human machine interface (HMI) controller 114, and a charging controller 116 for communication with various charging stations 118. The system 100 also includes a charger monitoring server 126 configured to communicate over the communications network 108 with the vehicles 102 and the charging stations 118. The charger monitoring server 126 may execute a charger service 128 configured to send update requests 124 for the installation of software updates 130 to the vehicles 102 and the charging stations 118. The charger monitoring server 126 may also be configured to receive testing reports 134 from the vehicles 102 and the charging stations 118 based on the software updates 130. Using the testing reports 134, the charger monitoring server 126 may determine whether the software updates 130 are causing issues and may perform various actions, such as reverting the software updates 130, rolling out the software updates 130 to additional vehicles 102, etc. It should be noted that the system 100 is only one example implementation, and more, fewer, and/or different system 100 elements may be used.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be a battery electric vehicle (BEV) powered by a traction battery and one or more electric motors. As a further possibility, the vehicle 102 may be a hybrid electric vehicle powered by both an internal combustion engine, a traction battery, and one or more electric motors. Hybrid vehicles 102 may come in various forms, such as a series hybrid electric vehicle, a parallel hybrid electrical vehicle, or a parallel/series hybrid electric vehicle. As the type and configuration of vehicle 102 may vary, the capabilities of the vehicle 102 may correspondingly vary. As some possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs) e.g. as defined by the International Organization for Standardization (ISO) 3779 and ISO 4030, globally unique identifiers (GUIDs), customer or fleet accounts, etc.

The vehicle 102 may include a plurality of controllers 104 configured to perform and manage various vehicle 102 functions under the power of the vehicle battery and/or drivetrain. As some non-limiting vehicle controller 104 examples: a powertrain controller 104 may be configured to provide control of engine operating components (e.g., idle control components, fuel delivery components, emissions control components, etc.) and for monitoring status of such engine operating components (e.g., status of engine codes); a body controller 104 may be configured to manage various power control functions such as exterior lighting, interior lighting, keyless entry, remote start, and point of access status verification (e.g., closure status of the hood, doors and/or trunk of the vehicle 102); a radio transceiver controller 104 may be configured to communicate with key fobs, mobile devices 122, or other local vehicle 102 devices; an autonomous controller 104 may be configured to provide commands to control the powertrain, steering, or other aspects of the vehicle 102; a climate control management controller 104 may be configured to provide control of heating and cooling system components (e.g., compressor clutch, blower fan, temperature sensors, etc.); a GNSS controller 104 may be configured to provide vehicle 102 location information; and an HMI controller 104 may be configured to receive user input via various buttons or other controls, as well as provide vehicle 102 status information to a driver, such as fuel level information, engine operating temperature information, and current location of the vehicle 102. The vehicle 102 may also be configured to power other devices external to the vehicle 102 using the vehicle 102 battery and/or drivetrain.

The TCU 106 is a controller 104 of the vehicle 102 that may be utilized for communication over the communications network 108. In an example, TCU 106 may be configured to provide telematics services to the vehicle 102. These services may include, as some non-limiting possibilities, navigation, turn-by-turn directions, health reports of the vehicle 102, local business search, accident reporting, and hands-free calling. The TCU 106 may include network hardware configured to facilitate communication between the vehicle 102 and other devices of the system 100. For example, the TCU 106 may include or otherwise access a cellular modem configured to facilitate communication with the communications network 108. The communications network 108 may include one or more interconnected communication networks such as the Internet, a cable television distribution network, a satellite link network, a local area network, and a telephone network, as some non-limiting examples.

The communications network 108 may provide communications services, such as packet-switched network services (e.g., Internet access, voice over internet protocol (VOIP) communication services), to devices connected to the communications network 108. For instance, the TCU 106 may access the communications network 108 via connection to one or more cellular towers. In another example, the TCU 106 may access the communications network 108 via a Wi-Fi connection.

A vehicle bus (not shown) may include various methods of communication available between the controllers 104, as well as between the TCU 106 and the vehicle controllers 104. As some non-limiting examples, a vehicle bus may include one or more of a controller area network (CAN), an Ethernet network, and a media-oriented system transfer (MOST) network.

Sensors 110 may include various hardware of the vehicle 102 that is used to collect information about its surroundings and status. As some non-limiting examples, the sensors 110 may include one or more of cameras (e.g., advanced driver assistance system (ADAS) cameras), ultrasonic transceivers, radio detection and ranging (RADAR) systems, and/or light detection and ranging (LIDAR) systems.

The GNSS controller 112 may be configured to provide information indicative of the current location of the vehicle 102. In an example, the GNSS controller 112 may be responsible for receiving signals from a GNSS constellation of satellites. This may allow the GNSS controller 112 to receive time information as well as for determining a precise location of the vehicle 102. The location determined by the GNSS controller 112 may be used for various tasks such as navigation or other location-based services.

The HMI controller 114 may be configured to provide an interface through which the vehicle 102 occupants may interact with the vehicle 102. The interface may include a touchscreen display, voice commands, and physical controls such as buttons and knobs. The HMI controller 114 may be configured to receive user input via the various buttons or other controls, as well as provide status information to a driver, such as fuel level information, engine operating temperature information, and current location of the vehicle 102. The HMI controller 114 may be configured to provide information to various displays within the vehicle 102, such as a center stack touchscreen, a gauge cluster screen, etc. The HMI controller 114 may accordingly allow the vehicle 102 occupants to access and control various systems such as navigation, entertainment, and climate control.

The charging controller 116 may be configured to manage the charging of the battery, including monitoring the charging status, managing the flow of electricity, and communicating with the power grid. The charging controller 116 may be in communication with a port for connection to a charging station 118, using a cable or other device that allows the vehicle 102 to be charged from an external power source. The charging stations 118 may be configured to direct and manage the transfer of energy between a power source and the vehicle 102. An external power source may provide direct current (DC) or alternating current (AC) electric power to the charging stations 118. The charging stations 118 may, in turn, have a charge connector for plugging into a respective charge port of the vehicle 102. The charge port may be any type of port configured to transfer power from the charging stations 118 to the vehicle 102. Alternatively, the charging stations 118 may be configured to transfer power using other approaches, such as a wireless inductive coupling. However, the charging stations 118 are connected to the charging controller 116, the charging stations 118 may include circuitry and controls to direct and manage the transfer of energy between the power source and the vehicle 102. The charging controller 116 of the vehicle 102 may also be configured to communicate data between the vehicle 102 and the charging station 118.

The vehicle information 120 includes records indicative of when the vehicle 102 is connected to the charging station 118. This information may be gleaned from the sensors 110, the GNSS controller 112, and/or from the charging controller 116. The charging station 118 may include at home or depot locations. The timing of the charging may be typically overnight but may be any time of the day. The charging station 118 may handle the charging of the vehicle 102 when the vehicle 102 is attached to the charging station 118, which takes tens of minutes to hours. This charging time may provide ample time for the installation of the software updates 130 as well as the validation of the software updates 130.

In another example, the vehicle information 120 includes information with respect to the configuration or other features of the vehicle 102. For example, the vehicle information 120 may indicate the software versions installed to the controllers 104 of the vehicle 102. In another example, the vehicle information 120 may include the make, model, and/or features installed to the vehicle 102 at manufacture and/or aftermarket. In yet another example, the vehicle information 120 may indicate a VIN or other identifier of the vehicle 102, which may be used to access vehicle information 120 with respect to the configuration and/or charging history of the vehicle 102.

The mobile devices 122 may be any of various types of portable computing device, such as cellular phones, tablet computers, smart watches, laptop computers, portable music players, or other devices having processing and communications capabilities. The mobile device 122 may include one or more processors configured to execute computer instructions, and a storage medium on which the computer-executable instructions and/or data may be maintained. The mobile devices 122 may be configured to connect to the TCU 106 or other controllers 104 of the vehicle 102 to provide communications services to the vehicle 102.

The charger monitoring server 126 may be an example of a networked computing device that is accessible to the vehicles 102, charging stations 118, and/or other devices over the communications network 108. The charger monitoring server 126 may be configured to execute the charger service 128 to perform the operations of the charger monitoring server 126 discussed herein. The vehicle 102 may send data from its sensors 110 over the communications network 108 to the charger monitoring server 126. The vehicle 102 may monitor its charging station 118 usage and may send vehicle information 120 over the communications network 108 to the charger monitoring server 126. In another electric vehicle (EV) example, the charger monitoring server 126 may be configured to receive vehicle information 120 from the charging stations 118 over the communications network 108 (e.g., as part of a billing process for charging station 118 usage or as a separate process).

The charger monitoring server 126 may maintain information about the vehicles 102. For example, the charger monitoring server 126 may receive from the communications network 108 information indicative of the quantity of vehicles 102 in a geographic area. In another example, the charger monitoring server 126 may receive vehicle information 120 from the communications network 108 indicative of the locations of the vehicles 102. This information may, for instance, be based on a home location database of the communications network 108 that maintains information indicative of which cells are connected to the TCUs 106 of which vehicles 102. In another example, the vehicles 102 may report their locations to the charger monitoring server 126, e.g., by using an GNSS controller 104 of the vehicle 102 to identify the vehicle location and sending that information by the TCU 106 over the communications network 108 to the charger monitoring server 126.

The charger monitoring server 126 may define an update list 132 of the vehicles 102 that are targeted to receive a software update 130. The update list 132 may include a listing of the vehicles 102 that are indicated as requiring a particular software update 130. The vehicles 102 may be indicated on the update list 132 by any of various vehicle identifiers, such as VIN, media access control (MAC) address, etc. Whether a software update 130 is required may be based on factors such as the make, model, year, location, features, charger type, etc. of the vehicle 102. In another example, the update list 132 may additionally or alternatively include a listing of the charging stations 118 that require updating.

The charger monitoring server 126 may maintain the software update 130 for the vehicles 102 and the charging stations 118 in a storage of the charger monitoring server 126. The software updates 130 may include any of various software updates 130 and/or configuration updates that are to be applied to the TCU 106 and/or other controllers 104 of the vehicle 102 and/or charging stations 118. In some cases, the software update 130 may add additional features to the vehicle 102 and/or charging station 118. In other cases, the software update 130 may include bugfixes or other updates to enhance the operation of existing features of the vehicle 102 and/or charging station 118. In some examples, the software update 130 may be designed for use with specific make or model of vehicle 102 and/or charging station 118, and/or for a specific model and/or version of controller 104 (or controllers 104) within the vehicle 102. In some cases, the software update 130 may include or otherwise be associated with a severity, e.g., whether the update should be installed immediately, or if the update may be installed over time in a background manner.

The charger monitoring server 126 may send update requests 124 to the vehicles 102 and/or the charging stations 118 on the update list 132. The update requests 124 may indicate which software update 130 to install, as well as timing information with respect to when to perform the installation of the software update 130.

If the vehicle 102 is not connected to the charging station 118, the vehicle 102 may utilize the TCU 106 to download the software update 130. In another example, the vehicle 102 may utilize one or more mobile devices 122 in communication with the vehicle 102 to download the software update 130. The vehicle 102 may connect to each mobile device 122, instruct them to download different segments of the software update 130, and then aggregate the data from each device to form the software update 130 for installation.

In many cases, a software update 130 includes an update to the vehicle 102 and also a corresponding update to the charging station 118. In such a case, both the vehicle 102 and the charging station 118 need to install their portions of the software update 130 for the software update 130 to be completed. To facilitate the install when such a coordinated interaction between the two is required, the charging station 118 may receive and store software updates 130 for both the vehicle 102 and the charging station 118. In an example, the charging station 118 may download Software updates 130 for both the vehicle 102 and the charging station 118 via a local Wi-Fi connection available to the charging station 118. This may be useful, as the charging station 118 may have a relatively more consistent connection to the communications network 108 that a moving vehicle 102. If the software package is corrupt, incomplete, or defective, the charging station 118 may retry until a complete package is downloaded and confirmed for both the charging station 118 and the vehicle 102, including several vehicle 102 module software packages.

The vehicle 102 may connect to the charging station 118 at a home or at a depot location. This connection may be overnight, but other times are possible. As charging takes tens of minutes to hours, this provides ample time for most software updates 130 to be installed and for validation to be performed.

In an example, predictive analytics and/or machine learning may be used identify reliable parking times and durations, ensuring the vehicle 102 is plugged in. For example, a vehicle 102 may have an 85% confidence interval of being plugged in between 1 am and 6 am, but a 95%+confidence interval between 3 am and 3:30 am. The duration for performing the software update 130 may be determined from testing and compared with routine plugging-in times. If the predicted time matches the download and validation durations, that time is targeted. The vehicle 102 may estimate the time needed for download and installation based on factors such as connection speed and data transfer rates over the communications network 108. This information helps estimate future update durations for similar vehicles 102. The estimated duration ensures there is enough time for the update before the vehicle 102 is needed again. Time at location may be inferred based on vehicle 102 usage history, state of charge, charge rate, and estimated charge duration.

In some examples, the planned time duration may be configured to consider the time involved in testing and reversion of the software update 130 if an issue is encountered. If the software cannot revert to the prior version or causes defects preventing further operation, deployment halts on devices that have yet to update, and in-process products begin the reversion process. The system 100 may alert the operator to manage any outliers the system cannot correct.

Software updates 130 to the vehicle 102 and charging station 118 may follow a predetermined sequence. Depending on the software package, the sequence may involve downloading to the charging station 118 first, followed by vehicle 102 modules, or vice versa. The sequence may be defined by the type of software. The vehicle 102 may download the software update 130 in segments and perform the installation once all segments are obtained, even if the vehicle 102 no longer remains connected to the charging station 118. The charging station 118 may communicate with the vehicle 102 to deploy the software update 130.

After a new software update 130 is installed on the vehicle 102, the previous software version may be stored in non-volatile memory of the vehicle 102 for a period until the new software is validated successfully on a specific number of vehicles 102 with a certain success rate. The level of validation may vary based on the update changes and system importance. If the new version performs poorly, the vehicle 102 may revert to the previous version automatically. If the update causes operational issues, the vehicle 102 may also automatically revert to the previous version. In some cases, the charging station 118 may download existing versions of software from the vehicle 102 modules for reversion if the new software has defects. This transfer may occur through a charge cable between the vehicle 102 and the charging station 118 but in other examples may be performed wirelessly. The charging station 118 may confirm the installation of the software update 130 to the vehicle 102 and may retain the previous version of the software for reversion if the validation fails.

After confirming a successful update, validation of operation and reporting may occur. In an example, once the installation of the software update 130 is complete, the vehicle 102 and charging station 118 undergo a sequence of operation modes to verify proper function. These modes include normal operations (charging, discharging, stop, start, derate, etc.) and preprogrammed regression testing. In some examples, the vehicle 102 and the charging station 118 may report their status via exterior sound exciters. In other examples, the vehicle 102 and the charging station 118 may communicate their status to one another through wireless radio frequency (RF) communication and/or using the charging cable connection.

Vehicles 102 may be identified and grouped to obtain statistically relevant samples from different market populations. These groups consider variations in climate, thermal temperatures from previous records, brands and series of vehicles 102, power levels, and installation characteristics.

The charger monitoring server 126 may maintain testing reports 134 with respect to the progress in sending and performing the software update 130 to the vehicles 102 on the update list 132. Likewise, testing reports 134 from the vehicles 102 may include information such as a result of the software update 130 (e.g., complete transfer, partial transfer, interrupted transfer, checksum error, unable to transfer, etc.), a location of the vehicle 102, whether the vehicle 102 has moved, whether the vehicle 102 is ON or OFF, download speed to the vehicle 102, RF signal parameters as measured for the vehicle 102, etc.

The charger monitoring server 126 may also maintain testing reports 134 with respect to the progress in sending and performing the software update 130 to the charging stations 118 on the update list 132. These reports may similarly indicate the update state of the charging station 118 side of software updates 130 that involve the charging station 118 as well.

Each relevant population may run operational modes, diagnostics, and regression testing, reporting successes, failures, and abnormal operations. Thresholds may be predetermined to understand if the standard deviation for the population exceeds acceptable limits or if any defects occur. Results are reported and flagged if any proper function fails. With acceptable reporting, the software continues to roll out. If any defects exceed population threshold metrics, the software reversion process initiates. This procedure may be done on hundreds to thousands of vehicles 102 simultaneously, which accelerates the verification process. Thus, by using the updates of customer or fleet vehicles 102, the vehicles 102 may be used as a testing fleet.

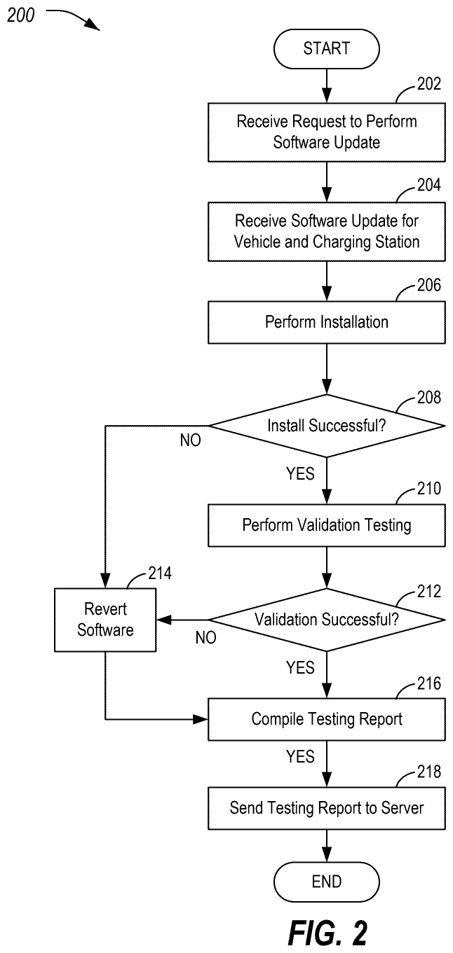

FIG. 2 illustrates an example process 200 for performing a simultaneous installation of a software update 130 to the vehicle 102 and to the charging station 118. In an example, the process 200 may be performed by the vehicle 102, charging station 118, and charger monitoring server 126, in communication over the communications network 108.

At operation 202, an update request 124 to install a software update 130 is received to the charging station 118. This update request 124 may have been received from the charger monitoring server 126, as discussed in further detail with respect to the process 300.

At operation 204, a software update 130 is received to the vehicle 102 and to the charging station 118. The installation of the software update 130 to the vehicle 102 and to the charging station 118 may follow a predetermined sequence. Depending on the software package, the sequence may involve downloading to the charging station 118 first, followed by to the controllers 104 of the vehicle 102, or vice versa.

In an example, the charging station 118 may receive the software update 130 for both the vehicle 102 and for the charging station 118 over the communications network 108. The charging station 118 may store the software updates 130 to its local storage. When the vehicle 102 is present, the charging station 118 may send the software update 130 for the vehicle 102 through a local network connection to the vehicle 102. This connection may be, for example, a wired connection over a data connection included in the charger cable connecting the charging station 118 to the vehicle 102. In another example, the data connection may be a wireless connection between the charging station 118 and the vehicle 102 such as a Wi-Fi connection. This approach may take advantage of the charging station 118 being stationary and typically receiving a stronger network signal than the vehicle 102. Moreover, this may also ensure that the vehicle 102 and the charging station 118 are operating using a corresponding pair of software updates 130.

In another example, the vehicle 102 may use one or more mobile devices 122 to receive the software update 130. In an example, the vehicle 102 may establish communications links with each mobile devices 122, instruct them to download different segments of the software update 130, and then aggregates the segments from each mobile device 122 to compile the software update 130 for the vehicle 102. In such an example, the vehicle 102 may download the software update 130 in segments, even if the vehicle no longer remains connected to the charging station 118.

The vehicle 102 and/or the charging station 118 may verify a signature of the software update 130, e.g., an MD5 hash or the like. If the software update 130 is corrupt, incomplete, or defective, the charging station 118 and/or the vehicle 102 may retry until a complete package is downloaded and confirmed for both the charging station 118 and the vehicle 102.

At operation 206, the vehicle 102 and the charging station 118 perform installation of the software update 130. The timing of the installation of the software update 130 may be indicated in the update request 124 received at operation 202. For the vehicle 102, the installation may include copying the current software of the one or more controller 104 being updated to a backup location, as well as installing the software update 130 to the one or more controllers 104 being updated. For the charging station 118, this may also include copying the current software to a backup location, as well as installing the software update 130 to the charging station 118.

In an example where the charging station 118 provides the software update 130 to the vehicle 102, the charging station 118 may communicate with the vehicle 102 to deploy the software update 130. The charging station 118 may use its data connection to the vehicle 102 to download the existing software before updating from the vehicle controllers 104 for reversion if the new software has issues. This transfer may occur through the charger cable but may also be performed wirelessly.

In an example where the vehicle 102 performs the download of the software update 130 using mobile devices 122, the vehicle 102 may download the software update 130 in segments and may perform the installation once all segments are obtained, even if the vehicle 102 no longer remains connected to the charging station 118.

Regardless, after the software update 130 is installed on the vehicle 102, the previous software version may be retained by the charging station 118 until the new software is validated successfully on a defined quantity of vehicles 102 with a defined success rate.

At operation 208, the vehicle 102 and the charging station 118 determine whether the installation of the software update 130 is successful. For instance, this may include the vehicle 102 determining that the software update 130 was able to be installed to the vehicle 102. This charging station 118 may also redundantly confirm the software installation on the vehicle 102 and may retain the previous software for reversion if the validation fails. This may also include confirming that the charging station 118 was updated, and that the backups were able to be stored.

If the software update 130 was installed, control proceeds to operation 210 to test the functionality of the updated software.

At operation 210, the vehicle 102 and the charging station 118 perform validation testing of the updated software after installation of the software updates 130 to the vehicle 102 and to the charging station 118. The validation may include the vehicle 102 and the charging station 118 undergoing a sequence of operation modes to verify proper function. The vehicle 102 and the charging station 118 may report status over the charging cable, wirelessly, and or via exterior sound exciters. These modes include normal operations (charging, discharging, stop, start, derate, etc.) and preprogrammed regression testing. This validation may be performed on hundreds to thousands of vehicles 102 simultaneously, which accelerates the verification process.

At operation 212, the charging station 118 determines whether the validation was successful. For example, if the new version performs poorly with respect to the validation testing, the vehicle 102 may revert to the previous version automatically. In another example, if the update causes operational issues, the vehicle 102 may also automatically revert to the previous version. If validation is unsuccessful, control proceeds to operation 214 to roll back the update. Similarly, if installation was unsuccessful at operation 208, control proceeds to operation 214 to roll back the update.

At operation 214, the vehicle 102 and/or the charging station 118 rolls back the installation of the software update 130. In an example, the backup version of the software may be reloaded to the controllers 104 of the vehicle 102 and/or to the charging station 118.

At operation 216, after operations 212 or 214, a testing report 134 is compiled. The testing report 134 may indicate the results of the installation to the vehicle 102 and to the charging station 118. Additionally, if the installation was successful, the testing report 134 may indicate the results of the validation. The testing report 134 may also include additional information, such as the VIN or other identifier of the vehicle 102 being updated.

At operation 218, the testing report 134 is sent to the charger monitoring server 126. In an example, the charging station 118 may collect the testing report 134 from the vehicle 102 and may send the testing report 134 to the charger monitoring server 126 over the communications network 108. In another example, the charging station 118 may additionally send its testing report 134 regarding the installation of the software update 130 to the charging station 118 to the charger monitoring server 126. In yet another example, the charging station 118 may collect testing reports 134 from a plurality of vehicles 102 and may send the collection of testing reports 134 to the charger monitoring server 126. In other example, the vehicle 102 may separately send its testing report 134 to the charger monitoring server 126. After operation 218, the process 200 ends.

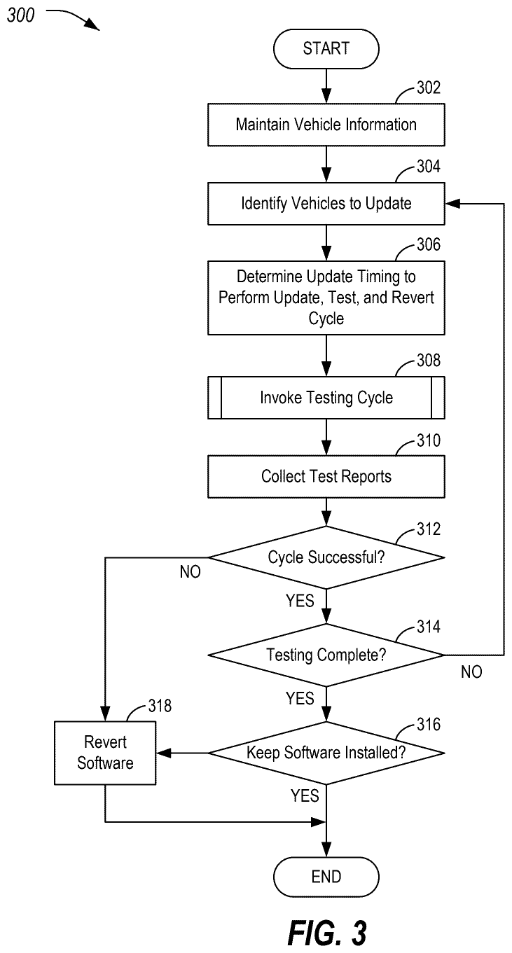

FIG. 3 illustrates an example process 300 for the charger monitoring server 126 implementing a testing approach to OTA software updates 130. In an example, as with the process 200, the process 300 may be performed by the vehicle 102, charging station 118, and charger monitoring server 126, in communication over the communications network 108.

At operation 302, the charger monitoring server 126 maintains vehicle information 120. This vehicle information 102 may include records indicative of when the vehicle 102 is historically connected to which of the charging station 118. In another example, the vehicle information 120 includes parameters with respect to the configuration or other features of the vehicle 102. This information may be received from various sources, such as from the vehicle 102 manufacturer, from the vehicles 102 responsive to being charged, from the charging stations 118 providing their charging histories to the charger monitoring server 126, etc.

At operation 304, the charger monitoring server 126 identifies vehicles 102 to receive a software update 130. In an example, the charger monitoring server 126 may identify an update list 132 of vehicles 102 to receive the software update 130. The update list 132 may include a listing of the vehicles 102 that are indicated as requiring a particular software update 130. The vehicles 102 may be indicated on the update list 132 by any of various vehicle identifiers, such as VIN, MAC address, etc. Whether a software update 130 is required may be based on factors such as the make, model, year, location, features, charger type, etc. of the vehicle 102. In another example, the update list 132 may additionally or alternatively include a listing of the charging stations 118 that require updating.

At operation 306, the charger monitoring server 126 determines, for each of the vehicles 102 on the update list 132, the update timing to perform the update, test, and/or revert cycles for the software update 130. In an example, the charger monitoring server 126 employs predictive analytics and machine learning to identify reliable parking times and durations, ensuring the vehicle 102 is plugged in. For example, the charger monitoring server 126 may have an 85% confidence interval of the vehicle 102 being plugged in between 1 am and 6 am, but a 95%+confidence interval between 3 am and 3:30 am.

The charger monitoring server 126 may determine the software update 130 duration from testing and compares it with routine plugging-in times. If the predicted time matches the download and validation durations, the charger monitoring server 126 may targets that time. The charger monitoring server 126 may estimate the time needed for download and installation based on the connection speed and data transfer rates. This information helps the charger monitoring server 126 to estimate future update durations for similar vehicles 102. The estimated duration ensures there is enough time for the software update 130 to be downloaded and installed (and optionally reverted) before the vehicle 102 is needed again. The charger monitoring server 126 may base the time at the location on factors including the vehicle usage history, state of charge, charge rate, and estimated charge duration.

For instance, the charger monitoring server 126 may determine that 3-3:30 am is the better time to perform the software update 130 based on the increased likelihood of the vehicle 102 being present at that time. In another example, if additional time is required for the software update 130 and validation, the charger monitoring server 126 may determine that 1-6 am is a better time to perform the software update 130.

At operation 308, the charger monitoring server 126 invokes a testing cycle for the vehicles 102 on the update list 132. To do so, the charger monitoring server 126 may send update requests 124 to the vehicles 102 and/or the charging stations 118. This may trigger the vehicles 102 and charging stations 118 to perform the operations of the process 200 discussed in detail above.

At operation 310, the charger monitoring server 126 collects testing reports 134. These may include the testing reports 134 sent at operation 218 from the vehicles 102 and charging stations 118 being updated according to the process 200.

At operation 312, the charger monitoring server 126 determines whether the testing cycle is successful. In an example, the charger monitoring server 126 may compare the results of the testing reports 134 against a threshold pass rate, to ensure that at least a minimum of the vehicles 102 and/or charging stations 118 were successful in applying the software updates 130. If so, control proceeds to operation 314.

At operation 314, the charger monitoring server 126 determines whether testing is complete. For example, the charger monitoring server 126 may be configured to run a set of cycles of testing for a software update 130 of different parameters, such as makes, models, configurations, locations, and/or features installed to the vehicle 102. These cycles may be run iteratively, to ensure that one or more cycles are successful before running additional cycles. For instance, a small cycle of vehicles 102 with a given set of parameters may receive and test the software update 130 (e.g., to build confidence) before the software update 130 is applied to larger set of vehicles 102 with those parameters. In another example, cycles may be constructed that first build confidence with a first set of parameters and then attempt the software update 130 for vehicles 102 with a different set of parameters. If the pass rate of the updating is above an abort threshold, then the charger monitoring server 126 may continue the updating with the additional cycles. If not, then the charger monitoring server 126 may elect to discontinue the testing. If testing is passing and not complete, then the process 300 returns to operation 304 to continue the updating with an additional update list 132. If testing is complete or the pass rate of the updating is below the abort threshold, control proceeds to operation 316.

At operation 316, the charger monitoring server 126 determines whether to keep the software update 130 on the vehicles 102 and/or the charging stations 118. For example, if the pass rate of the updating is above an abort threshold and the software update 130 is intended for production, then the software update 130 may be allowed to remain installed and the process 300 ends.

If, however, the pass rate is low, then the charger monitoring server 126 may elect not to keep the software update 130 installed and may instruct the vehicles 102 and/or charging stations 118 to revert to the backup software. If so, control passes to operation 318 to cause the charger monitoring server 126 to instruct the vehicles 102 and/or charging stations 118 to revert to the backup software. In another example, even if the software update 130 passes, if the software update 130 was installed experimentally (e.g., to test a new feature but not be retained), the charger monitoring server 126 may still pass to operation 318 to revert the software.

At operation 318, the charger monitoring server 126 sends an update request 124 to the vehicles 102 and/or charging stations 118 to revert to the backup software. In some examples, the update request 124 is sent to the vehicles 102 and also to the charging stations 118. In another example, the update request 124 is sent to the charging stations 118, which then instruct the vehicles 102 when they are connected to the charging stations 118 to revert the software update 130. This reversion may be performed, for example, using the backup software stored to the charging stations 118 during the application of the software update 130 to the vehicles 102. After operation 318, the process 300 ends.

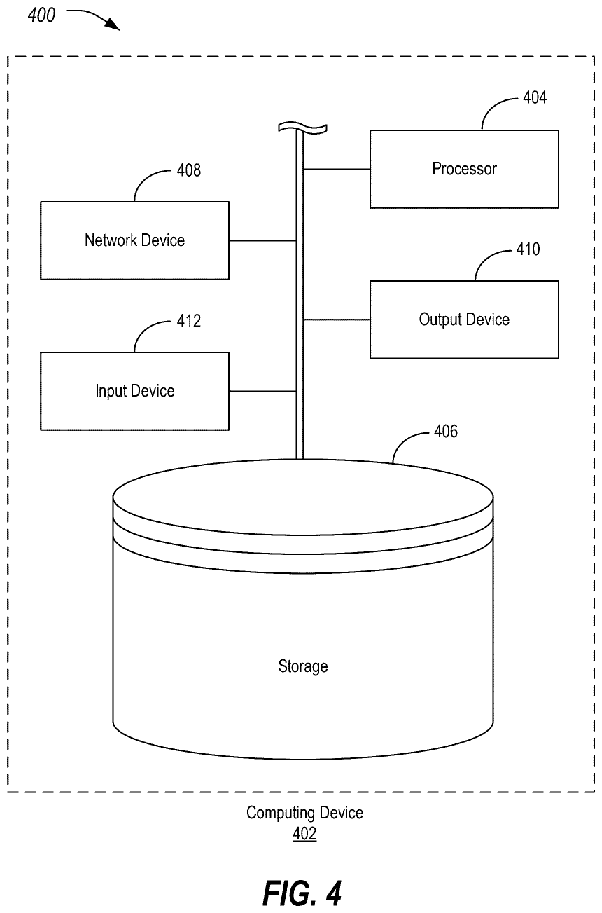

FIG. 4 illustrates an example computing device 402 for implementing an iterative testing approach to software updates 130 using consumer vehicles 102. Referring to FIG. 4, and with reference to FIGS. 1-6B, the vehicles 102, controllers 104, TCU 106, communications network 108, sensors 110, GNSS controller 112, HMI controller 114, charging controller 116, charging stations 118, mobile devices 122, charger monitoring server 126, are examples of such computing devices 402. Computing devices 402 generally include computer-executable instructions, such as those of the charger service 128 and software updates 130, where the instructions may be executable by one or more computing devices 402. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, such as the vehicle information 120, may be stored and transmitted using a variety of computer-readable media.

As shown, the computing device 402 may include a processor 404 that is operatively connected to a storage 406, a network device 408, an output device 810, and an input device 412. It should be noted that this is merely an example, and computing devices 402 with more, fewer, or different components may be used.

The processor 404 may include one or more integrated circuits that implement the functionality of a central processing unit (CPU) and/or graphics processing unit (GPU). In some examples, the processors 404 are a system on a chip (SoC) that integrates the functionality of the CPU and GPU. The SoC may optionally include other components such as, for example, the storage 406 and the network device 408 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 404 executes stored program instructions that are retrieved from the storage 406. The stored program instructions, accordingly, include software that controls the operation of the processors 404 to perform the operations described herein. The storage 406 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to an output device 410. The output device 410 may include a graphical or visual display device, such as an electronic display screen, projector, printer, or any other suitable device that reproduces a graphical display. As another example, the output device 410 may include an audio device, such as a loudspeaker or headphone. As yet a further example, the output device 410 may include a tactile device, such as a mechanically raiseable device that may, in an example, be configured to display braille or another physical output that may be touched to provide information to a user.

The input device 412 may include any of various devices that enable the computing device 402 to receive control input from users. Examples of suitable input devices 412 that receive human interface inputs may include keyboards, mice, trackballs, touchscreens, microphones, graphics tablets, and the like.

The network devices 408 may each include any of various devices that enable the described components to send and/or receive data from external devices over networks. Examples of suitable network devices 408 include an Ethernet interface, a Wi-Fi transceiver, a cellular transceiver, or a BLUETOOTH or BLE transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for iterative software updating using consumer vehicles, comprising:
sending update requests to install a software update to vehicles and charging stations in a cycle of testing, wherein the vehicles are included on an update list;
receiving testing reports from the vehicles and the charging stations;
responsive to the testing reports indicating success above a minimum success threshold, continuing to roll out the software update in an additional cycle of testing; and
otherwise, sending reversion update requests to roll back the software update to the vehicles and the charging stations.

2. The method of claim 1, further comprising:
sending a vehicle software update and a corresponding charging station software update to one of the charging stations, the vehicle software update to be installed to one of the vehicles, the corresponding charging station software update to be installed to the one of the charging stations;
receiving, from the one of the charging stations, a vehicle testing report indicating an outcome of installation of the vehicle software update to the one of the vehicles and also a charging station testing report indicating an outcome of installation of the charging station software update to the one of the charging stations.

3. The method of claim 2, wherein the outcome of the installation includes an indication of whether installation of the software update was successful, and if so, an indication of whether validation of functionality of the software update was successful.

4. The method of claim 2, further comprising storing a backup of vehicle software of the one of the vehicles before application of the software update to a storage of the one of the charging stations.

5. The method of claim 4, further comprising rolling back the software update by sending the backup of the vehicle software from the storage of the one of the charging stations to the one of the vehicles for reinstallation to the one of the vehicles.

6. The method of claim 4, wherein the software update is to be tested but not retained, and further comprising reverting to the backup of the vehicle software regardless of the testing reports.

7. The method of claim 1, further comprising:
identifying parking times and durations during which the vehicles are likely connected to the charging stations; and
indicating a timing to install the software update in the update requests.

8. The method of claim 1, further comprising:
including, on the update list, a first set of vehicles with a given set of parameters to test the software update before the software update is applied to larger set of vehicles with the given set of parameters; and
including, on a second update list for the additional cycle of testing, the larger set of vehicles with the given set of parameters.

9. The method of claim 1, further comprising:
including, on the update list, a first set of vehicles with a given set of parameters to test the software update before the software update is applied to vehicles with a different set of parameters; and
including, on a second update list for the additional cycle of testing, a second set of vehicles with the different set of parameters.

10. A system for iterative software updating using consumer vehicles, comprising:
a storage maintaining vehicle information, the vehicle information including records indicative of when vehicles are historically connected to which of charging stations and parameters with respect to configuration and/or features of the vehicles; and
a charger monitoring server configured to:
identify an update list of vehicles to receive a software update,
send update requests to apply the software update to the vehicles on the update list,
receive testing reports from the vehicles and the charging stations,
responsive to the testing reports indicating success above a minimum success threshold, continue to roll out the software update in an additional cycle of testing, and
otherwise, send reversion update requests to roll back the software update to the vehicles and the charging stations.

11. The system of claim 10, wherein the charger monitoring server is further configured to:
send a vehicle software update and a corresponding charging station software update to one of the charging stations, the vehicle software update to be installed to one of the vehicles, the corresponding charging station software update to be installed to the one of the charging stations; and
receive, from the one of the charging stations, a vehicle testing report indicating an outcome of installation of the vehicle software update to the one of the vehicles and also a charging station testing report indicating an outcome of installation of the charging station software update to the one of the charging stations.

12. The system of claim 11, wherein the outcome of the installation includes an indication of whether installation of the software update was successful, and if so, an indication of whether validation of functionality of the software update was successful.

13. The system of claim 11, wherein the charger monitoring server is further configured to store a backup of vehicle software of the one of the vehicles before application of the software update to a storage of the one of the charging stations.

14. The system of claim 13, wherein the charger monitoring server is further configured to roll back the software update by sending the backup of the vehicle software from the storage of the one of the charging stations to the one of the vehicles for reinstallation to the one of the vehicles.

15. The system of claim 13, wherein the software update is to be tested but not retained, and wherein the charger monitoring server is further configured to revert to the backup of the vehicle software regardless of the testing reports.

16. The system of claim 10, wherein the charger monitoring server is further configured to:
identify parking times and durations during which the vehicles are likely connected to the charging stations; and
indicate a timing to install the software update in the update requests.

17. The system of claim 10, wherein the charger monitoring server is further configured to:
include, on the update list, a first set of vehicles with a given set of parameters to test the software update before the software update is applied to larger set of vehicles with the given set of parameters; and
include, on a second update list for the additional cycle of testing, the larger set of vehicles with the given set of parameters.

18. The system of claim 10, wherein the charger monitoring server is further configured to:
include, on the update list, a first set of vehicles with a given set of parameters to test the software update before the software update is applied to vehicles with a different set of parameters; and
include, on a second update list for the additional cycle of testing, a second set of vehicles with the different set of parameters.

19. A non-transitory computer-readable medium comprising instructions for iterative software updating using consumer vehicles that, when executed by a charger monitoring server, cause the charger monitoring server to perform operations including to:
maintain vehicle information, the vehicle information including records indicative of when vehicles are historically connected to which of charging stations and parameters with respect to configuration and/or features of the vehicles;
identify an update list of vehicles to receive a software update;
send update requests to apply the software update to the vehicles on the update list;
receive testing reports from the vehicles and charging stations;
responsive to the testing reports indicating success above a minimum success threshold, continue to roll out the software update in an additional cycle of testing, and
otherwise, send reversion update requests to roll back the software update to the vehicles and the charging stations.

20. The medium of claim 19, further comprising instructions that, when executed by the charger monitoring server, cause the charger monitoring server to perform operations including to:
send a vehicle software update, and a corresponding charging station software update to one of the charging stations, the vehicle software update to be installed to one of the vehicles, the corresponding charging station software update to be installed to the one of the charging stations; and
receive, from the one of the charging stations, a vehicle testing report indicating an outcome of installation of the vehicle software update to the one of the vehicles and also a charging station testing report indicating an outcome of installation of the charging station software update to the one of the charging stations.
